(19) United States
(12) Patent Application Publication
(10) Pub. No.: US 2025/0370958 A1
(43) Pub. Date: Dec. 4, 2025

(54) DIRECTORY SNAPSHOT AND DATA MANAGEMENT

(71) Applicant: NetAPP, Inc, San Jose, CA (US)

(72) Inventor: Tijin George, San Jose, CA (US)

(21) Appl. No.: 19/227,224

(22) Filed: Jun. 3, 2025

Related U.S. Application Data
(60) Provisional application No. 63/655,668, filed on Jun. 4, 2024.

(51) Int. Cl. G06F 16/11; G06F 16/18

(52) U.S. Cl. CPC G06F 16/128; G06F 16/1873

(57) ABSTRACT

Techniques are provided for directory snapshot and data management. Conventional snapshot functionality creates snapshots at a volume level. Volume level snapshots are inadequate for scale-out storage architectures because a single volume snapshot of a shared storage resource may not satisfy different data protection requirements of clients using the shared storage resource. The disclosed techniques are capable of creating snapshots at a directory level. The directory level snapshots are created and maintained using an inode identity map to track active inode numbers of directory files that have diverged. Snapshot generation numbers are used to determine whether a file is part of a directory for which snapshotting is enabled. A version map used to track versions of a file modified across different directory snapshots and an active file system. A delayed free metafile is used to determine whether file block numbers of a directory can be freed.

### RELATED APPLICATIONS

This application claims priority to U.S. Provisional Patent Application, titled “DIRECTORY SNAPSHOT AND DATA MANAGEMENT”, filed on Jun. 4, 2024 and accorded Application No. 63/655,668, which is incorporated herein by reference.

### BACKGROUND

Many storage environments implement data replication, backup, snapshotting, and/or other storage functionality for data loss protection and non-disruptive client access. For example, a node provides clients with access to data stored within a volume through an active file system. The data is organized into files and directories by the active file system. Snapshots are created as backups of the volume. A snapshot corresponds to a point-in-time representation of the volume. A baseline snapshot is an initial snapshot that captures all the data of the volume. Subsequent snapshots are created as incremental snapshots that each capture changes since a prior snapshot. A snapshot is used to restore the volume back to a point-in-time captured by the snapshot.

### DESCRIPTION OF THE DRAWINGS

FIG. 1 is a block diagram illustrating an example of a system for directory snapshot and data management in accordance with an embodiment of the present technology.

FIG. 2A is a flow chart illustrating an example method for directory snapshot and data management in accordance with an embodiment of the present technology.

FIG. 2B is a flow chart illustrating an example method for processing a modify operation targeting storage that includes a protected directory in accordance with an embodiment of the present technology.

FIG. 2C is a flow chart illustrating an example method for processing an operation targeting a file within a protected directory in accordance with an embodiment of the present technology.

FIG. 2D is a flow chart illustrating an example method for processing a modify operation targeting a file within a protected directory in accordance with an embodiment of the present technology.

FIG. 2E is a flow chart illustrating an example method for implementing a block-freeing mechanism for storage that includes a protected directory in accordance with an embodiment of the present technology.

FIG. 3A is a block diagram illustrating an example of a system for directory snapshot and data management in accordance with an embodiment of the present technology.

FIG. 3B is a block diagram illustrating an example of a snapshot metafile in accordance with an embodiment of the present technology.

FIG. 4 is a block diagram illustrating an example of a hierarchy in accordance with an embodiment of the present technology.

FIG. 5 is a block diagram illustrating an example of a hierarchy in accordance with an embodiment of the present technology.

FIG. 6 is a block diagram illustrating an example of a node in accordance with an embodiment of the present technology.

FIG. 7 is an example of a computer readable medium in which an embodiment of the present technology may be implemented.

### DETAILED DESCRIPTION

Systems and methods are provided for directory snapshot and data management. Conventional snapshots are created for an entire volume, and capture data and metadata of a file system of the volume at a particular point-in-time. A snapshot of a volume can be used to restore the file system back to a point-in-time captured by the snapshot. Unfortunately, volume level or file system level snapshots are inadequate for scale-out architectures where there is an overall large and scalable storage resource used by multiple clients for different use cases. Thus, a snapshot of the storage resource may not suit all the different clients and use cases for the storage resource. For example, a first client utilizes a first portion of the storage resources for virtual machine disks, a second client utilizes a second portion of the storage resource as a scratch space for testing, a third client utilizes a third another portion of the storage resource as a database, etc. Each client and use case have different data management and snapshot requirements, and thus a single snapshot or the same snapshot policy for the entire storage resource is inadequate and inefficient for satisfying all of the different data management and snapshot requirements. For example, some clients may require daily snapshots, while other clients may require weekly snapshots.

The disclosed directory snapshot and data management techniques solve these deficiencies of conventional data management and snapshot techniques by creating snapshots at a directory level. In some embodiments, a directory is a hierarchical structure that provides a logical grouping for shared resources such as files and folders that can be grouped, managed, and accessed together. In some embodiments, a directory within a shared namespace is implemented as a container to organize files, folders, and resources within the shared namespace. In some embodiments where multiple clients are provided with access to a shared storage resource, a directory within the shared storage resource is assigned to a particular client. The client is granted access to files and folders within the directory assigned to the client. The client is restricted from accessing directories assigned to other clients. In this way, directories may be used to securely provide clients with access to specific data within a shared resource. In some embodiments, directories are implemented for a scale-out shared namespace such that a directory can be accessed from multiple nodes within a cluster. In this way, directories are used to logically group storage and data of a shared resource for access by a particular client in a secure manner where other clients cannot access a directory assigned to the client.

Directory level snapshots provide a client with the ability to manage how data within a specific directory is protected. The directory level snapshots are created and managed using an inode identity map. The inode identity map tracks active inode numbers of files that have diverged from original inode numbers of the files. That is, an original inode number is assigned to a file when the file is created. After a directory level snapshot of the file is create, the file may be modified. When the file is modified, a new version of the file with a new inode number is created to preserve the original file and original inode number captured by the directory level snapshot. Accordingly, the inode identity map is used to track the original inode numbers and active inode numbers of a current or most recently created inode number for a particular version of a file.

The inode identity map is used to track active inode numbers of files newly created in the directory level snapshot so that access can be provided to the files. Each directory level snapshot is assigned a unique snapshot generation number, which can be used to determine whether a file is part of a directory protected by snapshotting. A snapshot metafile is created for a snapshot. The snapshot metafile is populated with the inode identity map and a snapshot generation number for the directory level snapshot. In this way, the snapshot metafile is used to create, manage, and perform operations upon directory level snapshots of directories.

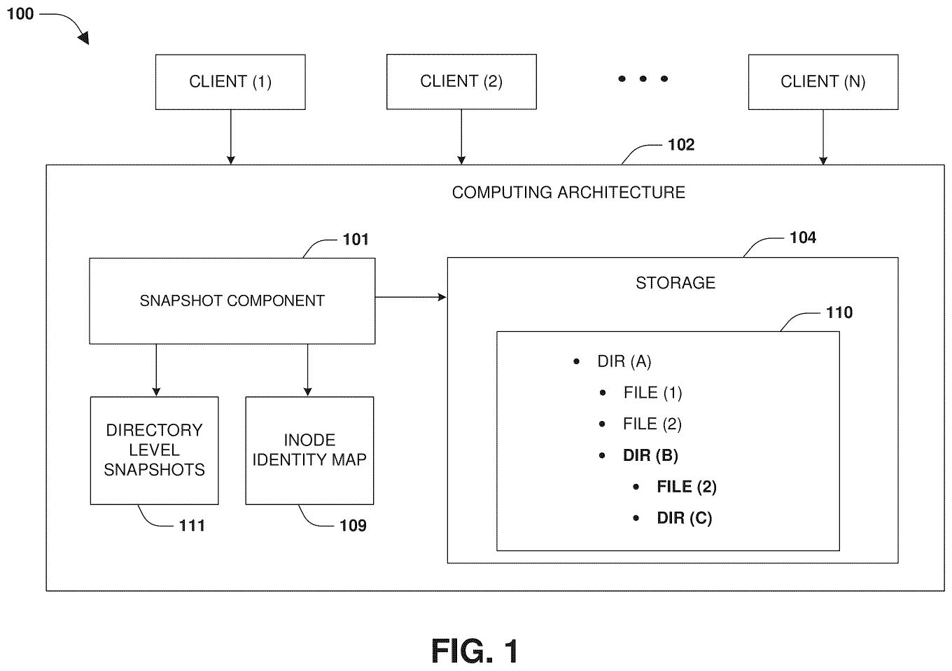

FIG. 1 is a block diagram illustrating an example of a system 100 for directory snapshot and data management. The system 100 includes a computing architecture 102 that manages storage used by clients. In some embodiments, the computing architecture 102 may be a scale-out system with shared resources. With the scale-out system, a single namespace may be used to simplify management of the storage for multiple clients. Some scale-out systems use volumes underneath as low-level management containers. The volumes may be aggregated under a single namespace. However, the use of a single namespace may introduce scaling limits. For example, the scaling limits may relate to a restriction on a total number of volumes (e.g., a volume implemented as a container in which applications, databases, and files store data; a Kubernetes persistent volume container; a Docker volume; or any other storage container that is provisioned from storage of a cluster) that can be hosted by a cluster of the scale-out system. This restriction places an artificial limit on the scale-out system, which is dictated by how much a single volume can scale if the load of an entire cluster resides on the same volume at any time because the scale-out system may have a maximum size limit for how large a given volume can dynamically scale out in size (e.g., 300 TB or some other size limit). Some scale-out systems utilize true single namespaces where one namespace expands to the entire cluster. If a storage operating system is to be extended to a single namespace architecture, then data management operations cannot be performed at a volume level due to several limits such as limited snapshots, etc.

Many scale-out systems support directory granular data management. Directory granular data management allows users to implement storage management functionality at a per directory granularity. Implementing storage management at a directory level provides for finer grained management of data compared to volume level storage operations. Because data is managed at a finer granularity, unwanted space is not otherwise consumed by managing data at a larger than necessary granularity (e.g., wasted storage space to create a backup of an entire volume where merely the contents of a particular directory of the volume are to be backed up). Directory level storage operations may be integrated into workloads such as artificial intelligence and machine learning (“AI/ML”) model training that uses snapshots as an efficient mechanism to creating model checkpoints that are created on-demand.

Directory granular data management may be implemented to on-demand create application consistent snapshots that require low latency because applications are fenced until snapshot creation is complete. The disclosed techniques provide the ability to create directory level directory snapshots of select directories. Directory level snapshots improves the efficiency of data management, such as directory snapshot restore functionality, directory cloning functionality, replication functionality, etc. It may be appreciated that the disclosed techniques are not limited to snapshots of directories, but may also apply to qtrees and individual files as qtree level snapshots and file level snapshots. As used herein, a protected directory is a top-level directory for which snapshotting is enabled. A protected directory meta-directory is created for each protected directory. The protected directory meta-directory is used to track metafiles related to directory level snapshots for a particular protected directory. In this way, directory level snapshots are created for protected directories, and metafiles related to the directory level snapshots are tracked using a protected directory meta-directory

The disclosed snapshot techniques enable protection of any number of directories, qtrees, or files using snapshots that are not constrained to a particular number of directories, qtrees, or files that can be protected. In some embodiments, snapshot limits can be defined and implemented for a particular directory. For example, a user may define a maximum number of snapshots that are allowed for a directory, similar to how a volume may be limited to a particular number of snapshots (e.g., 1024 or any other number). In some embodiments, scheduled snapshots (e.g., daily snapshots, weekly snapshots, or hourly snapshots) and on-demand snapshots (e.g., snapshots created in response to a snapshot request) are supported for directories, qtrees, and files.

In some embodiments, techniques are disclosed for creating a snapshot of a directory, qtree, or file in a performant and storage space efficient manner. That is, near instant snapshots of directories, qtrees, and files can be created within seconds in a storage efficient manner. The storage space consumed by the snapshots is similar to the storage space consumed by unique data stored within a protected directory for which the snapshots are being created. In this way, the creation and storage of snapshots is fast and storage efficient where snapshots are created in a scalable manner and can be created in seconds or sub-second time.

In some embodiments, various storage management functions may be implemented as part of directory level snapshots. For example, snapshot difference identification is supported at a block-level granularity for a protected directory (e.g., the ability to identify data differences between two snapshots of the protected directory). The disclosed snapshot techniques are extensible to support functionality such as performing a restore of merely a single directory, qtree, or file using a snapshot, creating snapshot clones of a single directory, qtree, or file, replicating a single directory, qtree, or file, and/or other snapshot-based data management such as generating snapshot storage consumption reports and creating snapshots of select directories within a same hierarchy.

Various metafiles and structures are used for the creation and management of snapshots, such as directory level snapshots 111. A file version hierarchy is used to track different versions of a file that may change between snapshots of a directory. That is, a first snapshot may capture an original file within a directory. The original file has an inode number used to refer to the original file. After the first snapshot is created, the original file may be modified as a modified version of the original file. Subsequently, a second snapshot of the directory may be created. As part of creating the modified version of the original file, a new file is created with a different inode number than the inode number of original file. A file requestor of the original file (e.g., an external file handle or internal metadata that may request access to the original file) may continue to use the inode number of the original file. In this way, the unique of the original file is maintained through the use of the original inode number even though the new file with the different inode number was created.

A version map is used to maintain the uniqueness of the original file for the file requestor. The version map maps the original inode number to inode numbers of subsequent versions of the file. The file requestor of a file can be an external client file handle with a cached value of the original inode number, internal metadata such as directory entries that include the original inode numbers, etc. The version map may include a mapping of the original inode number to an active inode number that corresponds to a current inode number of a latest version of the file. The mapping provides client file handles, buffer caches, directory entries representing information about directories, and other storage file system structures with the ability to use the original inode number without additional modifications even when the current inode number for the same file changes across snapshots. For example, a file A has an inode number X at the time of creation. A snapshot is created of a parent directory, and no further action is taken for file A at the moment. When file A is to be modified for the first time, then another file (a new version of file A) is created with inode number Y that represents an active file system version of the new version of file A going forward. The disk inode of inode number X will be marked as read only so that no operation can modify the inode number X file tree (buftree) because it is part of the snapshot. Even though the buftrees are shared, reference counting may be implemented in some instances. In other instances, a block-free mechanism is used to protect blocks that are shared between snapshots and the active file system.

Modifications to a file in the active file system may include append operations, truncate operations, and/or overwrite operations. These modification operations can overwrite existing file block numbers that are shared with prior snapshots. During overwrite, functionality is implemented to ensure that these file block numbers are not freed if the file block numbers are shared with a prior snapshot. For example, a file may include a file block number (A). An overwrite operation may be executed upon the file. If the file block number (A) is shared with a prior snapshot that includes the file block number (A) (e.g., a directory snapshot of a directory that includes the file), then the file block number (A) is retained instead of being freed.

In some embodiments of implementing a block-freeing mechanism, file block numbers may be shared across file versions in a protected directory. The file block numbers may not rely on reference counting used to track how many times a block of data is referenced (e.g., multiple files may reference the same block of data such as due to deduplication). This applies to file block numbers shared across versions of the same file, and reference counting will continue to exist for block sharing across files or for deduplication within a file. In an example of referencing counting, a reference count is maintained for a block of data such that each time the block of data is referenced, the reference count is incremented. The reference count is decremented when a reference to the block of data no longer exists. The block of data is freed if the reference count reaches 0.

Techniques are provided to ensure that shared file block numbers are not freed if a valid reference to the file block number still exists. A file block number may be overwritten in the active file system. If the file block number is associated with a file that has older file versions, then the file block number (an overwritten file block number) may be added to a delayed free metafile. The delayed free metafile may be indexed with keys such as a key: (inode number, file block number, and a per snapshot generation number). If the key already exists, then the file block number can be immediately freed since the new entry would be the second time or more that the file block number is overwritten in the active file system. Once the delayed free metafile reaches a threshold size, the entries may be sorted by (inode number, file block number), and will be compared with the last snapshot whose generation number is less than the snapshot generation number in the key. If the file block number exists in the last snapshot, then the entry is removed from the delayed free metafile. The sorting will ensure that batch lookups and decisions can be made for file block numbers that fall within the same indirect. If the file block number is not shared, then the entry can be freed. File block number freeing may also be implemented during snapshot deletion.

The disclosed techniques may be implemented by a snapshot component 101. The snapshot component 101 may be hosted by the computing architecture 102 or hosted external to the computing architecture 102. The computing architecture 102 may provide clients with access to storage 104. The storage 104 may include a hierarchy 110 of directories and files. The snapshot component 101 may be capable of creating snapshots of select directories of the hierarchy 110, such as a snapshot of a directory (B) and contents within the directory (B).

The computing architecture 102 is capable of efficiently processing read operations from the active file system in a performant manner because no additional resolution is required to identify data within the active file system being accessed. A write path is also performant because the decision to free an overwritten file block number (e.g., a file block number of a data being overwritten by a write operation) can be pushed into the background outside of the write path. Read operations to read data from snapshots are performant because snapshot file inodes have valid indirect entries that can be used to traverse down through a buftree to access the data being read.

In some embodiments, an inode identity map 109 is used by the snapshot component 101 for creating and managing snapshots of directories. Each snapshot will maintain an inode identity map of active inode numbers in the snapshot that have diverged from an original inode number. The inode identity map may also track inode numbers that are newly created in the snapshot. In some embodiments, the first snapshot created after snapshot protection is enabled on a directory. A record of new inode numbers is created, and a baseline replication may perform a directory traversal to populate the inode identity map. In some embodiments, a background scanner may be implemented to perform a spider walk to record existing inode numbers as part of the inode identity map.

A key of the inode identity map is the original inode number, and a value will be the latest inode version number version used in a snapshot. Versions of the inode identity map are maintained per snapshot using the file version hierarchy. In some embodiments, a snapshot metafile includes the inode identity map for accurately representing the inodes modified in the snapshot as either new keys added for new inode numbers or values of existing keys that changed for modified inode numbers. The inode numbers of versions of the inode identity map and corresponding snapshot information may be maintained in a snapshot metafile that is kept in the protected directory meta-directory associated with the protected directory.

The directory entries of a snapshot are associated with original inode numbers. When an operation uses an original inode number to access a file, a look up to the inode identity map is performed to resolve an active inode number version to access by the operation. The lookup is to a fixed index within the inode identity map, and is very quick and efficient. In some embodiments, client file handles use original inode numbers, and so read operations are resolved using the inode identity map to identify the active inode number version to use. Also, the inode identity map has a summary of inodes that were modified in the snapshot. In some embodiments, the inode identity map can be cached (e.g., cached in a processor or memory core) to avoid lookups during every I/O for opening the client file handles.

In some embodiments, a map data structure is used for the inode identity map. The inode identity map may provide a static file offset that is mapped to a value. The static file offset may be calculated as a key inode number. Because the inode identity map is searched using a static lookup, the lookup time is very efficient.

In some embodiments, per snapshot generation numbers are assigned to each snapshot. The snapshot generation numbers are monotonically increasing numbers, and a latest copy of a snapshot generation number may be tracked persistently in the inode of the protected directory. The snapshot generation number may be tracked in a disk inode when a file or sub-directory is created or modified within the protected directory. The snapshot generation number is used to identify if a file or directory is being modified for the first time after the last snapshot so that inode version processing can be initiated or ignored.

For new files being created, a determination is made as to whether the files belong to a protected directory. If a file is within a qtree, then a qtreeid can be used for the determination. For directory support, similar to the qtreeid, a new identifier per directory is provided to track the protected directory. The new identifier per directory may be tracked for sub-directories of a parent protected directory for which snapshotting is enabled. If snapshotting is enabled on an existing directory, then the sub-directories can be updated with the new identifier in the background using a spider traversal that is implemented by the background scanner. Intermediate lookups for the protected directory are done via inode to pathname (“I2P”) lookups.

In some embodiments of creating a snapshot of a directory, the directory is fenced where client I/O directed to the directory is suspended until the directory is unfenced after snapshot creation. A file version of the inode identity map is created. A per snapshot generation number is incremented for the snapshot that is being created. The file version of the inode identity map and the snapshot generation number are recorded within a snapshot metafile for the snapshot.

In some embodiments, a file version of the top-level protected directory is created (e.g., different directories within a directory hierarchy may be protected through snapshotting). The file version of the top-level protected directory reflects a unique inode with a unique generation number, which represents an entry point for accessing the snapshot. For example, the unique inode may be used as an entry point for traversing the snapshot to identify specific directories and files captured by the snapshot. In some embodiments, a consistency point is performed as part of snapshot creation to store data in dirty buffers to storage (disk). The consistency point is where data is stored from memory to storage in order to make the storage consistent (e.g., operations are logged into memory before being subsequently stored to storage by a consistency point operation). Once the storage is consistent, the snapshot may be created. In some embodiments, instead of performing the consistency point, certain operations (e.g., critical operations that are performed in order to achieve data and/or metadata consistency) are logged through non-volatile logging during the snapshot generation process.

In some embodiments, various operations may be performed after creation of a snapshot for a directory. For lookup operations directed to the snapshot or an active file system, the inode identity map is queried to obtain a relevant version of an original inode number. The inode identity map and/or queried inode numbers may be cached to avoid recurring lookups to the inode identity map during consecutive reads. Read operations to the active file system are processed by the computing architecture 102 without further modifications. However, a modification operation (e.g., a write operation or truncate operation) is executed by loading an inode into memory in order to access a snapshot generation number in the inode. If the snapshot generation number is the same as a generation number for an active file system (e.g., a top directory generation number), then the modification operation is processed normally. If the generation numbers do not match, then the previously described file version creation process is performed where a new version of a file targeted by the modification operation and new inode number for the new version of the file is created and mapped to the original inode number. This process is computationally efficient because the process has a small one time cost that is occurred only once after a last snapshot is created for modification operations on an existing file.

In some embodiments, a file delete operation targeting a file captured by a directory level snapshot is received. A shared portion of an inode of the file is identified as being shared with a previous snapshot. Accordingly, the shared portion is not freed as part of executing the file delete operation. At a subsequent point in time, shared data of the shared portion is evaluated for potentially being freed when the previous snapshot is deleted. The key for this inode is removed from the inode identity map as part of the file delete operation.

In some embodiments, a snapshot read operation targeting a snapshot of a directory is received. As part of performing the snapshot read operation, a directory lookup for the directory being read is redirected to a top directory version corresponding to the snapshot. Once the directory lookup locates a directory entry associated with the top directory version of the directory, the inode identity map is queried for the original inode number in order to locate the version of the inode number in the snapshot. The version of the inode number is used for further lookups and/or to read the requested data.

In some embodiments, a snapshot delete operation to delete a snapshot of a directory is received. The inode entity map is used as part of performing the snapshot delete operation. For example, there may be snapshot (L), snapshot (M), and snapshot (R). When snapshot (M) is deleted, the inode version maps (inode identity maps) of snapshot (L), snapshot (M), and snapshot (R) are compared. In some embodiments, the comparison is performed using a snapshot difference operation that can efficiently compare the inode version maps because the inode version maps were clones of one another at certain points in time and have shared buftree sections. The contents of key values in the different sections of the inode version maps (e.g., a key paired with a value) are individually compared across neighboring snapshots to determine what action to perform as part of the snapshot delete operation. One action may be an inode buftree deletion where a snapshot difference operation of file versions between neighbor snapshots is performed, and unique data in a file version under deletion is deleted. Another action may be an inode version number deletion that deletes a particular version of an inode number corresponding to a particular version of a file being deleted. Once the snapshot is deleted, the particular version of the inode number is freed because there is no need for an inode number to represent the file version in the snapshot that has been deleted. As part of performing the snapshot delete operation, a metafile cleanup may be performed such as for the inode identity map in the snapshot to remove any stale metadata (e.g., remove unused key value pairs).

In some embodiments, keys of inode numbers are deleted as part of maintaining a map for a snapshot of a directory. The map, such as an inode identity map, may include keys and values. A key may be set to an inode number. Thus, a map may include keys of inode numbers that are mapped to values. Because a directory may be restored or cloned from a snapshot of the directory, keys of inode numbers can be used in future snapshots. A key of an inode number is freed if the key of the inode number is not used by any neighboring or future snapshots. Otherwise, the key of the inode number can be reused. However, reuse of the key of the inode number could cause key collisions in the inode identity map. Accordingly, an inode reference count map is created and used if a directory restore operation or a directory clone operation is performed for a directory. The freeing of a key of an inode number is delayed until the inode reference count map is updated. The inode reference count may be updated using a crawler job by a background scanner after a directory restore operation or a directory clone operation is performed for the directory. Once updated inode reference counts are populated into the inode reference count map, any inodes having keys with a zero inode reference count are freed.

In some embodiments, a directory restore operation is received for restoring a particular directory from a snapshot of the directory. The directory restore operation may be performed while preserving how buftrees are shared between snapshots. The directory restore operation follows a similar workflow as the previously described snapshot creation operation. As part of performing the directory restore operation, the source snapshot is locked from modification or deletion. While the source snapshot is locked, clients may be provided with access to a latest view of the source snapshot. In the background, a scan is run by a background scanner to create new inode versions for the restored directory. These new inode versions use reference counting based buftree sharing with inodes in the source snapshot. Once the scan is complete, the lock from the source snapshot is removed. Subsequently, the source snapshot can be freed by evaluating the neighboring snapshots and decrementing reference counts for freed blocks without having to take into consideration any sharing of a source snapshot buftree of the source snapshot.

In some embodiments, a directory clone operation may be performed for a directory. The directory clone operation may be similar to the previously described directory restore operation, except that the protected directory will be a new directory. In particular, the source snapshot is locked to prevent modification or deletion. A clone directory is created using the snapshot of the directory. However, the clone directory is not split from the directory as a standalone directory until requested by the user. Until such a request, the clone directory shares data with the directory.

In some embodiments, an operation is performed to transfer data of a directory to a destination directory using one or more snapshots of the directory. In the destination directory, read operations to an active file system may be redirected to a last successfully transferred snapshot. The read operations may be redirected until all of the data is transferred. Once all of the data is transferred a final (latest) snapshot can be registered as a successfully transferred snapshot.

In some embodiments, directory replication may be performed for a directory using snapshots of the directory. In particular, a snapshot difference operation is performed between two snapshots of the directory (e.g., a current snapshot of the directory and a prior snapshot last used to replicate data of the directory to a replication destination). The snapshot difference operation is performed to identify a delta between the two snapshots of the directory, which represents differences of the directory between the two snapshots. The delta between the two snapshots is transferred to the replication destination.

In some embodiments, directory and snapshot storage reporting is provided. For example, the storage reporting may relate to an amount of data that has diverged since a last snapshot of a directory. In another example, the storage reporting may relate to storage used when block ownership is transferred to a previous snapshot upon deletion of a current snapshot. In this way, various metrics can be used as part of the storage reporting. These metrics can be tracked on a per protected directory basis, and can be reported as space-related snapshot information.

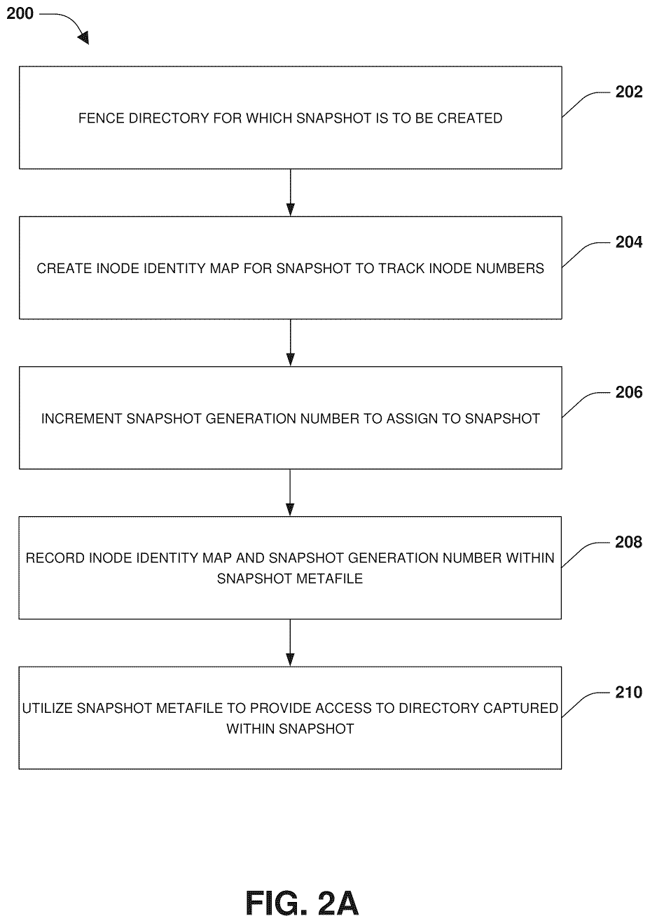

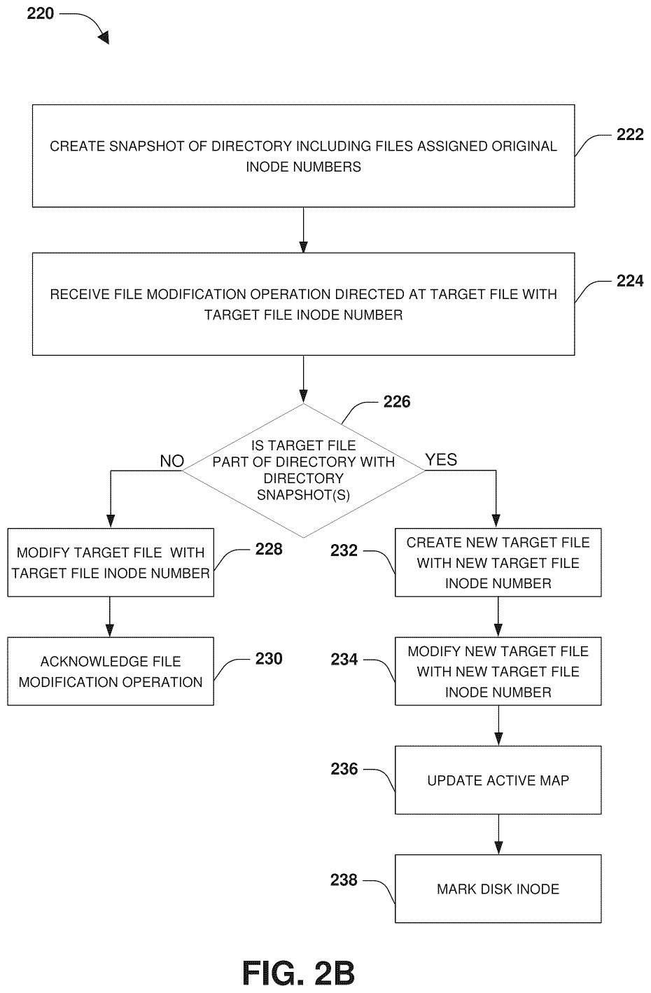

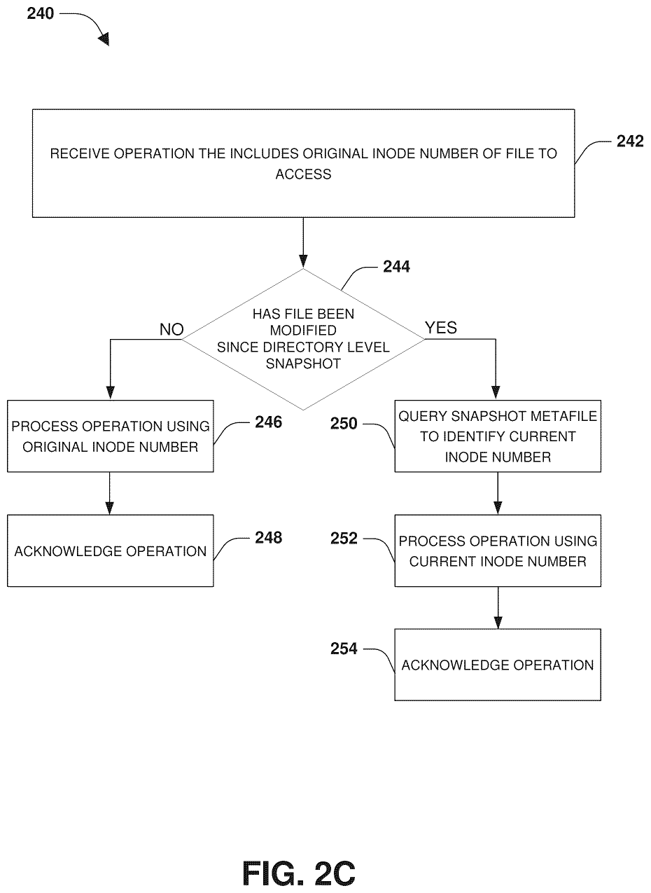

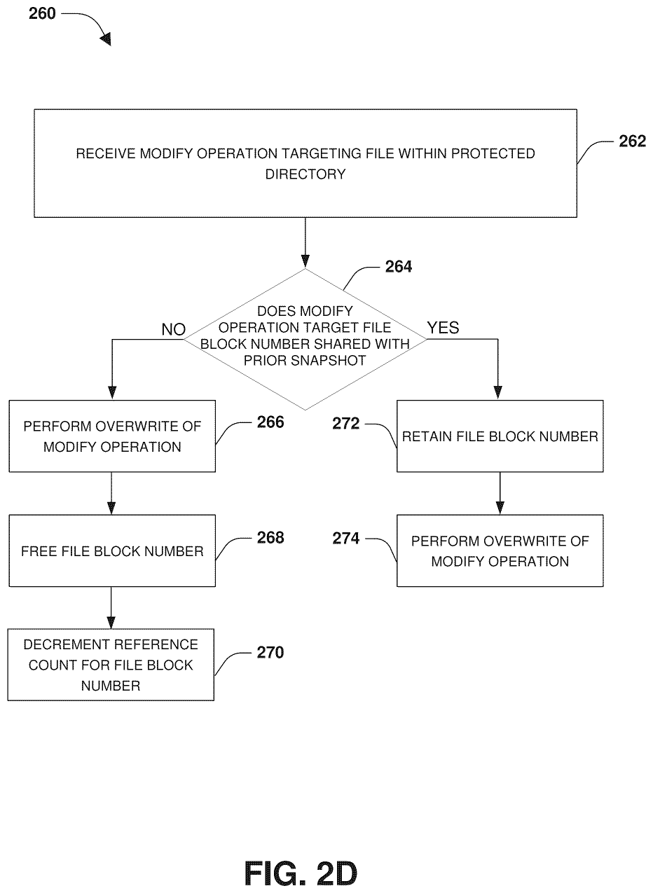

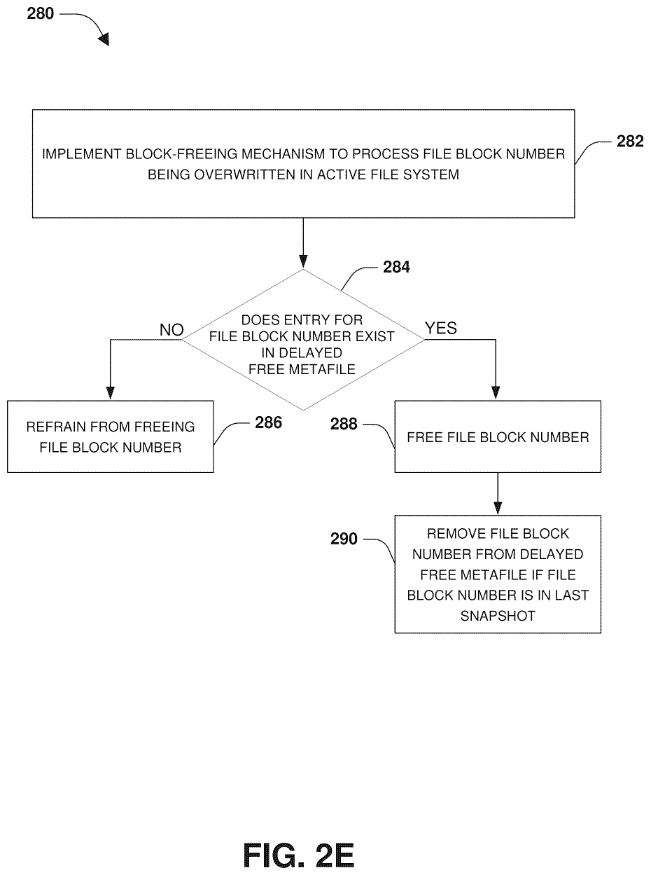

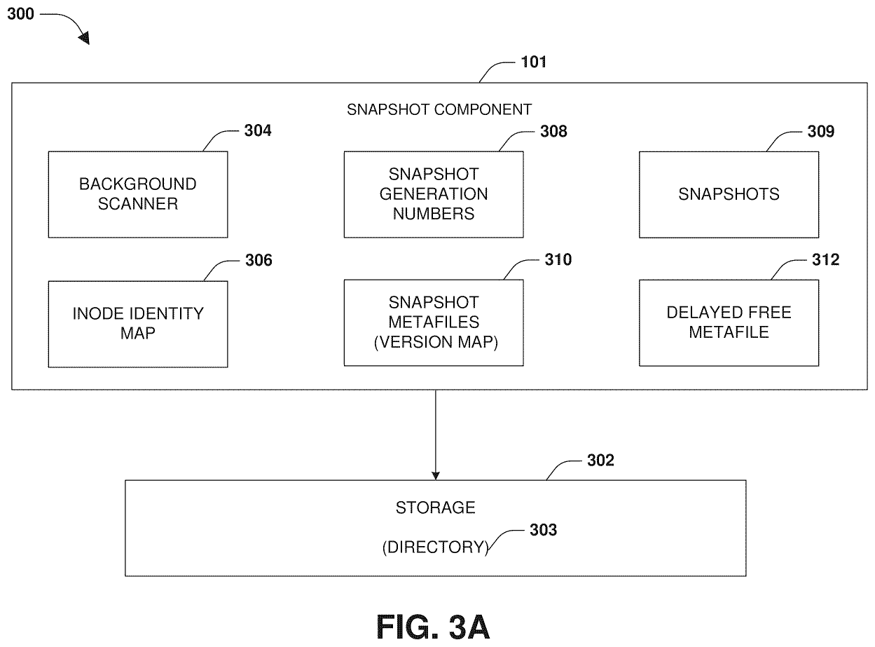

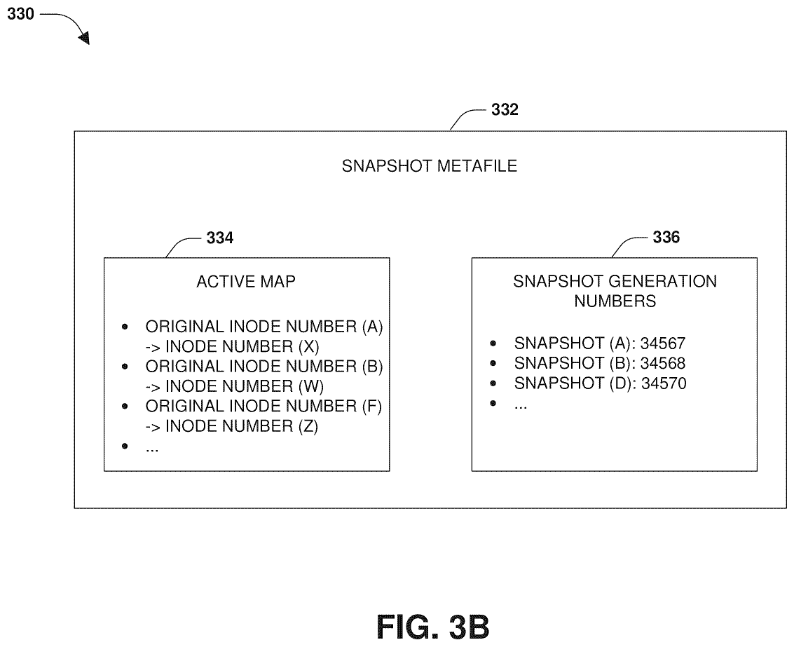

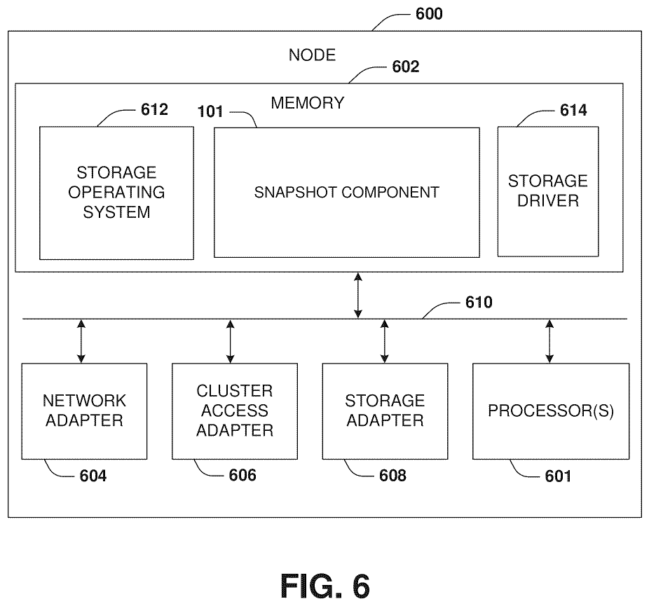

FIG. 2A is a flow chart illustrating an example method 200 for directory snapshot and data management, which is described in relation to system 300 of FIG. 3A. A snapshot component 101 may be configured to create snapshots 309 of directories qtrees, and/or files stored within storage 302, such as the creation of directory level snapshots. In some embodiments, the snapshot component 101 may be implemented as software and/or hardware of a computing device. The snapshot component 101 and/or the storage 302 may be hosted together or separately on-premise, within a cloud computing environment, by a service, a virtual machine, a container, a scale-out computing architecture, a multi-tenant computing architecture, a shared computing architecture, or any other computing environment such as the computing architecture 102 of FIG. 1 or node 600 of FIG. 6.

In some embodiments, the snapshot component 101 may create a snapshot of a directory 303 stored within the storage 302. As part of creating the snapshot, the directory 303 is fenced, during operation 202 of method 200. The directory 303 is fenced such that client I/O operations are not executed upon the directory 303 during creation of the snapshot. During operation 204 of method 200, an inode identity map 306 is created for the snapshot that is being created. The inode identity map 306 tracks active inode number of files of the directory 303 that have diverged from original inode numbers of the files. The inode identity map 306 is used to track active inode numbers of files newly created in the snapshot.

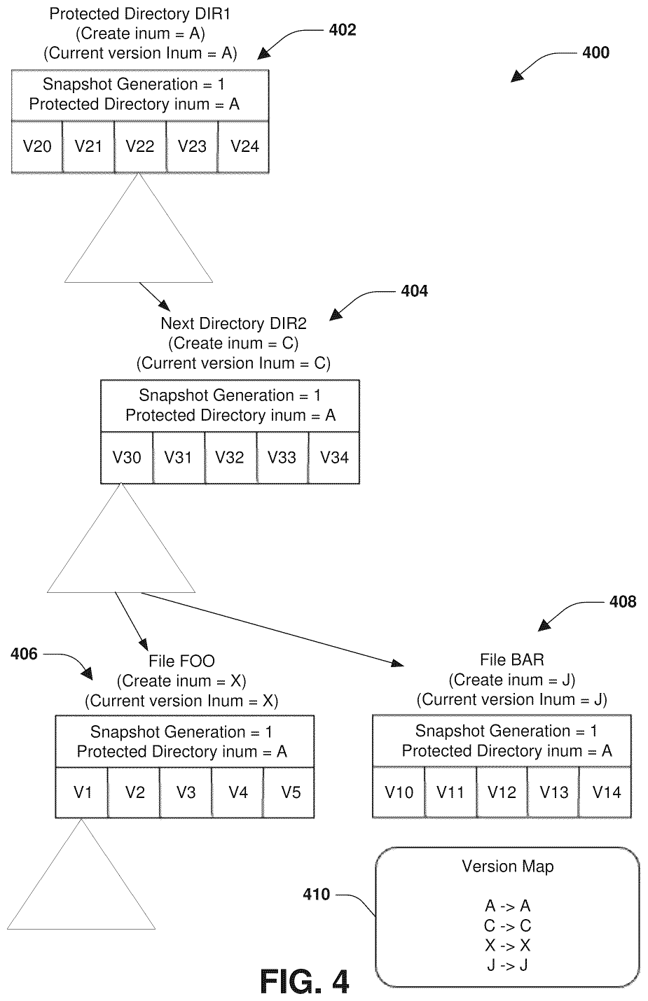

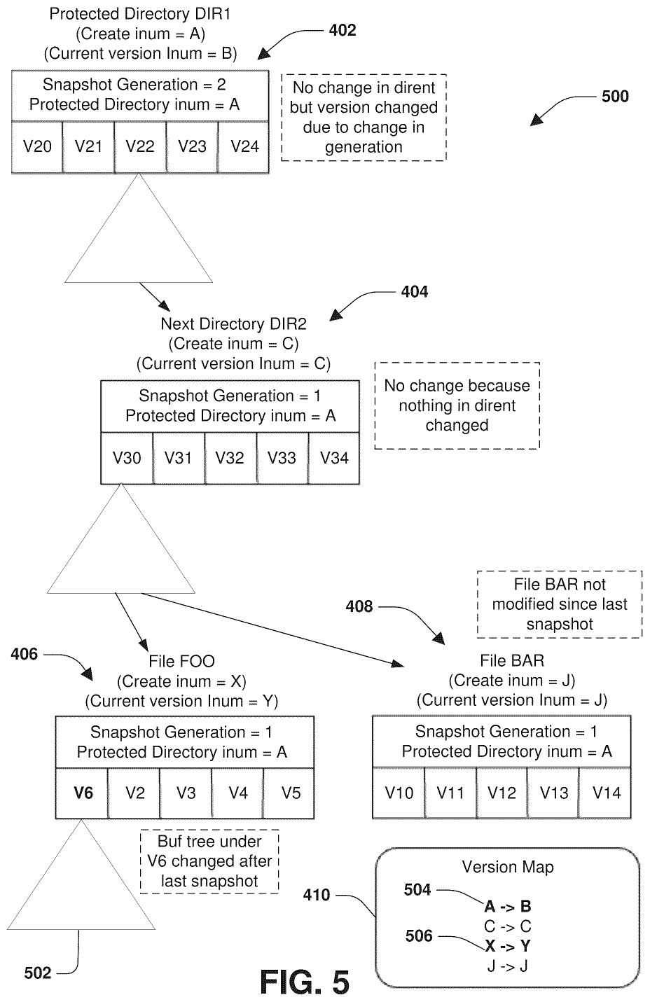

In some embodiments, other metafiles may be created such as a version map. In some embodiments, the version map may be a standalone map or may be implemented as part of the inode identity map 306. The version map is used to track versions of a file modified across different snapshots and an active file system by mapping an original inode number of the file to subsequently generated inode numbers for the versions of the file. The original inode number may be provided to a file requestor for accessing the file. In some embodiments, the file requestor may be an external client file handle that caches the original inode number, internal metadata of a filesystem, directory entries, or other entities that may request access to the file. In some embodiments, the version map is created to map keys to values. A key for a file corresponds to an original inode number for the file. A value, mapped to the key, corresponds to a latest/active inode number for a latest version of the file. The various maps and metafiles are used to track versions of files within the directory 303 according to file version hierarchies, such as the file version hierarchies that will be described in relation to FIGS. 4 and 5.

When an operation is received from the file requestor for the file, the version map is used to identify an inode version of the file targeted by the operation. In particular, the operation may include the original inode number. The original inode number is used as a lookup into the version map to identify a particular inode version of the file that is targeted by the operation and is mapped to the original inode number.

During operation 206 of method 200, a snapshot generation number is assigned for the snapshot. Each new snapshot is assigned a unique snapshot generation number. For example, the snapshot generation numbers may be incrementally increasing numbers used to uniquely identify snapshots. The snapshot generation numbers can be used as part of traversing through a snapshot of a directory to located requested data. Each top level directory between two snapshots is unique, and thus snapshots have unique snapshot generation numbers corresponding to the top level directories. In this way, snapshot generation numbers 308 are maintained by the snapshot component 101.

During operation 208 of method 200, the inode identity map 306 and the snapshot generation number are recorded within a snapshot metafile that may be part of snapshot metafiles 310 maintained by the snapshot component 101. During operation 210 of method 200, the snapshot metafile may be used to provide access to the directory captured within the snapshot. For example, the snapshot metafile may be used to identify and access a particular version of a requested file within the directory. FIG. 3B illustrates an example 330 of an embodiment of a snapshot metafile 332. The snapshot metafile 332 may include an active map 334. The active map 334 maps original inode numbers of a files to inode numbers of subsequent versions of the files. For example, an original inode number (A) for a file may be mapped to an inode number (X) of a current version of the file because new inode numbers and file versions of the file may be created each time the file is modified/overwritten. The snapshot metafile 332 includes snapshot generation numbers 336 that are assigned to snapshots, such as a snapshot generation number 34567 assigned to a snapshot (A). The active map 334 and the snapshot generation numbers 336 are used to locate a particular file being requested. For example, a request for the file may include the original inode number (A). The original inode number (A) may be used as a key to query the active map 334 to identify the current inode number (X) as a value mapped to the key. The inode number (X) and a snapshot generation number of a snapshot capturing a desired version of the file may be used to access the file.

In some embodiments of creating the snapshot of the directory, a consistency point is performed to store modified data from buffers (e.g., data being written by write operations logged into buffers in memory) to storage. The modified data may correspond to client I/O operations redirected to the buffers based upon the directory being fenced during snapshot creation of the snapshot of the directory. Once the snapshot has been created, the directory is unfenced to unsuspend the client I/O operations that were suspended based upon the directory being fenced.

In some embodiments of providing access to the directory captured by the snapshot, a background scanner 304 is implemented to scan directories (e.g., scan directories of an active file system, such as by scanning a file version hierarchy). The directories are scanned to determine whether a file is part of a protected directory for which snapshotting is enabled. The background scanner 304 may be implemented as a crawler that crawls through the directories such as to a directory (e.g., a top-level directory) that has a snapshot generation identifier. The snapshot generation identifier may be used to identify and provide access to the directory captured by the snapshot, or may be used to determine that a snapshot of the directory is to be created.

FIG. 2B is a flow chart illustrating an example method 220 for processing a modify operation targeting storage that includes a protected directory. During operation 222 of method 220, a snapshot of a directory is created such as by using the method 200 of FIG. 2A. The directory may include files that are assigned original inode numbers or current inode numbers at the time the snapshot is created. The snapshot may capture a state of the directory along with subdirectories and/or files within the directory and subdirectories.

During operation 224 of method 220, a file modification operation is received. The file modification operation may target a file (a target file having a target file inode number) within a volume that includes the directory for which the snapshot was created. The snapshot may exclude directories and files of the volume that are not part of the directory and subdirectories of the directory. Accordingly, a determination is made as to whether the target file is part of the directory for which the snapshot was created, during operation 226 of method 220. The determination may relate to whether the target file has a parent directory for which snapshotting is enabled. If the target file does not have a parent directory for which snapshotting is enabled, then the target file is modified based upon the file modification operation, during operation 228 of method 220. Based upon successful execution of the file modification operation, an acknowledgement is returned for the file modification operation, during operation 230 of method 220.

If the target file is part of the directory (or has a parent directory for which snapshotting has been enabled), a new target file is created with a new target file inode number, during operation 232 of method 220. The new target file is created so that the original/current version of the target file is preserved such as because the snapshot of the directory includes the original/current version of the target file. During operation 234 of method 220, the file modification operation is executed upon the new target file with the new target file inode number. During operation 236 of method 220, an active map is updated to map the target file inode number of the target file to the new target file inode number of the new target file. During operation 238, a disk inode of target file inode number of the target file is marked as read only so that no operation can modify a buftree of the target file inode number of the target file. Once the file modification operation is successful execute, the acknowledgement is returned for the file modification operation.

FIG. 2C is a flow chart illustrating an example method 240 for processing an operation targeting a file within a directory, such as a protected directory for which one or more snapshots have been created. During operation 242 of method 240, an operation is received that includes an original inode number of a file to access. The file may be part of a directory for which a snapshot has been created. During operation 244 of method 240, a determination is made as to whether the file has been modified since creation of the snapshot of the directory. If the file has not been modified since creation of the snapshot (e.g., no new versions of the file have been created since snapshotting was enabled for the directory), then the operation is processed using the original inode number to access the file, during operation 246 of method 240. Once the operation successfully completes, the operation is acknowledged, during operation 248 of method 240.

If the file has been modified, then a snapshot metafile is queried to identify a current inode number of the file and/or a snapshot generation number of the snapshot, during operation 250 of method 240. For example, the original inode number may be used as a key to query the active map to identify the current inode number as a value mapped to the key. The inode number and the snapshot generation number of the snapshot capturing a desired version of the file may be used to access the file. During operation 252 of method 240, the operation is processed using the current inode number. The current inode number is used to access the desired version of the file targeted by the operation. Once the operation successfully completes, the operation is acknowledged, during operation 254 of method 240.

FIG. 2D is a flow chart illustrating an example method 260 for processing a modify operation targeting a file within a directory, such as a protected directory for which one or more snapshots have been created. During operation 262 of method 260, a modify operation is received. The modify operation may target a file within the protected directory. During operation 264 of method 260, a determination is made as to whether the modify operation targets a file block number of the file that is shared with a prior snapshot of the file. That is, file block numbers may be shared amongst directory level snapshots that are incremental in nature. The shared file block numbers may pertain to data that is shared and common between a current snapshot and a prior snapshot of the protected directory.

If the modify operation targets a file block number shared with the prior snapshot, then an overwrite operation is performed as part of executing the modify operation, during operation 266 of method 260. The overwrite operation may create a new file block number and write data of the modify operation to the new file block number. During operation 268 of method 260, the file block number that is shared with the prior snapshot is freed so that the file block number can be subsequently allocated for storing other data. During operation 270 of method 260, a reference count for the file block number is decremented. In particular, referencing counting may be implemented for file block numbers that are shared amongst snapshots, in some embodiments.

If the file block number targeted by the modify operation is not shared with the prior snapshot, then the file block number is retained, during operation 272 of method 260. During operation 274 of method 260, the overwrite operation is performed as part of executing the modify operation. The overwrite operation may create the new file block number and write data of the modify operation to the new file block number.

In some embodiments, a delayed free metafile 312 is used to determine whether file block numbers can be freed in response to an overwrite operation for a file block number. The delayed free metafile 312 may include keys that are associated with file block numbers of blocks of storage. Accordingly, the delayed free metafile 312 may be implemented and used as part of performing the operations of method 260, and may be used as part of the operations of method 280.

FIG. 2E is a flow chart illustrating an example method 280 for implementing a block-freeing mechanism for storage that includes a directory, such as a protected directory for which one or more snapshots have been created. In some embodiments, a block-freeing mechanism may be used to protect blocks shared between snapshots of the directory and an active file system. The block-freeing mechanism may be used for shared blocks between readable versions of data (e.g., read-only snapshots) and a single writeable version of data (e.g., an active file system). In such instances where the block-freeing mechanism is implemented, reference counting may not be used or relied upon. However, the reference counting may be used for shared blocks between multiple writeable versions of data such as where deduplication within the active file system has been performed to implement block sharing.

During operation 282 of method 280, the block-freeing mechanism is implemented to process a file block number being overwritten in an active file system. During operation 284 of method 280, a determination is made as to whether an entry for the file block number exists in a delayed free metafile. That is, the delayed free metafile is used to determine whether file block numbers can be freed in response to an overwrite operation for the file block number. The delayed free metafile may include keys that are associated with file block numbers of blocks of storage. If an entry does not exist within the delayed free metafile, then the file block number is not freed, during operation 286 of method 280. If an entry exists within the delayed free metafile, then the file block number is freed, during operation 288 of method 280. If the file block number is part of a last/latest snapshot, then the file block number is removed from the delayed free metafile, during operation 290 of method 280.

As discussed, the disclosed techniques provide for granular level snapshots, such as snapshots of specific directories, qtrees, or files. The granular level snapshots provide the ability to implement storage operations at a granular level as opposed to conventional volume level snapshots and operations. The granular level snapshots may be selectively implemented for certain directories, qtrees, and/or files within shared resources where certain portions of the shared resources have storage protection and data management requirements that are different than other portions of the shared resources. In this way, different clients that utilize portions of the shared resources can implement their own specific storage management policies such as backup policies, replication policies, restore policies, cloning policies, etc.

FIG. 4 is a block diagram illustrating an example 400 of a file version hierarchy used to track different version of files within a directory captured by one or more directory level snapshots. A first snapshot metafile may be maintained for a first directory 402 that is a protected directory for which snapshotting is enabled. As part of the first snapshot metafile, a snapshot generation number is set to 1, an original inode number for the first directory 402 is (A), and a current (latest) version inode number (active inode number) for the first directory 402 is (A). A second snapshot metafile may be maintained for a second directory 404. As part of the second directory 404, an original inode number for the second directory 404 is (C) and a current version inode number for the second directory 404 is (C). The second directory 404 may include a file FOO 406 and a file BAR 408. The file FOO 406 may have an original inode number (X) and a current version inode number of (X). The file BAR 408 may have an original inode number (J) and a current version inode number of (J). A version map 410 is maintained to map original inode numbers to current version inode numbers, such as original inode number (A) to current version inode number (A), original inode number (C) to current version inode number (C), original inode number (X) to current version inode number (X), and original inode number (J) to current version inode number (J).

FIG. 5 is a block diagram illustrating an example 500 of the file version hierarchy used to track different version of files within a directory captured by one or more directory level snapshots. The file version hierarchy may have been modified since example 400 of FIG. 4. In particular, the snapshot generation number may have been incremented to 2 based upon a new directory level snapshot being created. Also, the current version inode number for the first directory 402 may have been changed from (A) to (B) because there has been a modification 502 to the file FOO 406 since the creation of a latest snapshot. This also results in the current version inode number for the file FOO 406 changing from (X) to (Y). The version map 410 is updated with an updated mapping 504 that now maps the original inode number (A) for the first directory 402 to the current version inode number (B) for the first directory 402. The version map 410 is updated with an updated mapping 506 that now maps the original inode number (X) for the file FOO 406 to the current version inode number (Y) for the file FOO 406.

In some embodiments, a method is provided. The method includes generating a snapshot of a directory to manage and protect the directory by: creating an inode identity map for the snapshot, wherein the inode identity map tracks: active inode numbers of files in the directory that have diverged from original inode numbers of the files based upon new versions of files with new inode numbers being created in response to the files being modified after creation of the snapshot; and active inode numbers of files newly created in the snapshot; and assigning a snapshot generation number to the snapshot, wherein each new snapshot of the directory is assigned an incrementally increasing snapshot generation number; and utilizing the inode identity map and snapshot generation number to provide access to the directory captured by the snapshot, wherein the snapshot generation number is used to determine whether a requested file is part of the directory protected by snapshotting.

In some embodiments, a method is provided. The method includes generating a snapshot of a directory to manage and protect the directory stored within a storage system, wherein the snapshot is generated within the storage system by: creating an inode identity map for the snapshot, wherein the inode identity map tracks: active inode numbers of files in the directory that have diverged from original inode numbers of the files based upon new versions of files with new inode numbers being created within the storage system in response to the files being modified after creation of the snapshot; and active inode numbers of files newly created in the snapshot stored within the storage system; and assigning a snapshot generation number to the snapshot; in response to the storage system receiving an operation targeting a version of a requested file captured by the snapshot: utilizing the snapshot generation number to determine that the version of the requested file is part of the directory protected by snapshotting; and utilizing the inode identity map to identify a storage location within the storage system of the version of the requested file captured by the snapshot; and executing the operation to access the version of the requested file at the storage location within the storage system.

In some embodiments, the method includes tracking versions of a file within the directory based upon the file being modified across different snapshots and an active file system by mapping an original inode number of the file to subsequently generated inode numbers for the versions of the file.

In some embodiments, the method includes tracking, within a version map, versions of a file modified across different snapshots and an active file system by mapping an original inode number of the file to subsequently generated inode numbers for the versions of the file; providing the original inode number to a file requestor; and in response to receiving an operation from the file requestor for the file, utilizing the version map to identify an inode number of a version of the file targeted by the operation, wherein the operation includes the original inode number used as a lookup into the version map.

In some embodiments, the method includes executing an operation to modify a file captured by the snapshot, wherein a new file is created with a new inode number different than an original inode number of the file captured by the snapshot, wherein at least some inode content is shared amongst the original inode number and the new inode number; and in response to receiving an access operation for the file, utilizing a version map to direct the access operation to the new file having the new inode number, wherein the access operation specifies the original inode number used as a lookup to identify the new inode number.

In some embodiments, the method includes utilizing a block-freeing mechanism to protect blocks shared between snapshots of the directory and an active file system, wherein the block-freeing mechanism selectively frees file block numbers based upon whether the file block numbers are overwritten in the active file system and exist in at least one snapshot.

In some embodiments, the method includes selectively utilizing reference counting for a first set of shared blocks between multiple writeable versions of data; and selectively utilizing a block-freeing mechanism for a second set of shared blocks between a readable version and a single writeable version of data, wherein the reference counting is disabled for the second set of shared blocks.

In some embodiments, the method includes maintaining a delayed free metafile with keys associated with file bock numbers of blocks of storage used to store the snapshot; and utilizing the delayed free metafile to determine whether a file block number can be freed in response to an overwrite command for the file block number.

In some embodiments, the method includes tracking versions of the files within the directory utilizing file version hierarchies to track different inodes used for different versions of a file.

In some embodiments, the method includes performing a consistency point to store modified data from buffers to storage, wherein the modified data corresponds to client input/output (I/O) operations redirected to the buffers based upon the directory being fenced during creation of the snapshot; and in response to the snapshot being created, unfencing the directory to unsuspend client I/O operations.

In some embodiments, the method includes creating a version map that maps keys to values, wherein a key for a file corresponds to an original inode number for the file and a value, mapped to the key, corresponds to a latest inode number for a latest version of the file.

In some embodiments, the method includes utilizing the snapshot generation numbers as part of a traversal through the snapshot of the directory, wherein each top directory associated with two snapshots is unique.

In some embodiments, the method includes in response to modifying a file of the directory for a first time, increasing the snapshot generation number for a new version of the file that is created based upon the modification of the file.

In some embodiments, the method includes executing a background scanner to scan directories to determine whether a file is part of a protected directory for which snapshotting is enabled.

In some embodiments, a computing device is provided. The computing device includes a memory storing instructions and a processor coupled to the memory, the processor configured to execute the instructions to generate a snapshot of a directory by: creating an inode identity map for the snapshot, wherein the inode identity map tracks active inode numbers of files in the directory that have diverged from original inode numbers of the files; assigning a snapshot generation number to the snapshot, wherein each new snapshot of the directory is assigned an incrementally increasing snapshot generation number; and recording the inode identity map and the snapshot generation number within a snapshot metafile for the snapshot; and utilize the snapshot metafile to provide access to the directory captured by the snapshot.

In some embodiments, a computing device is provided. The computing device includes a memory storing instructions and a processor coupled to the memory, the processor configured to execute the instructions to perform operations including: generating a snapshot of a directory to manage and protect the directory stored within a storage system, wherein the snapshot is generated within the storage system by: creating an inode identity map for the snapshot, wherein the inode identity map tracks: active inode numbers of files in the directory that have diverged from original inode numbers of the files based upon new versions of files with new inode numbers being created within the storage system in response to the files being modified after creation of the snapshot; and active inode numbers of files newly created in the snapshot stored within the storage system; and assigning a snapshot generation number to the snapshot; in response to the storage system receiving an operation targeting a version of a requested file captured by the snapshot: utilizing the snapshot generation number to determine that the version of the requested file is part of the directory protected by snapshotting; and utilizing the inode identity map to identify a storage location within the storage system of the version of the requested file captured by the snapshot; and executing the operation to access the version of the requested file at the storage location within the storage system.

In some embodiments, the machine executable code causes the computing device to track versions of a file within the directory based upon the file being modified across different snapshots and an active file system by mapping an original inode number of the file to subsequently generated inode numbers for the versions of the file.

In some embodiments, the machine executable code causes the computing device to track, within a version map, versions of a file modified across different snapshots and an active file system by mapping an original inode number of the file to subsequently generated inode numbers for the versions of the file; in response to receiving an operation from a file requestor for the file, utilize the version map to identify an inode number of a version of the file targeted by the operation, wherein the operation includes the original inode number used as a lookup into the version map.

In some embodiments, the machine executable code causes the computing device to execute an operation to modify a file captured by the snapshot, wherein a new file is created with a new inode number different than an original inode number of the file captured by the snapshot, wherein at least some inode content is shared amongst the original inode number and the new inode number.

In some embodiments, a non-transitory machine readable medium is provided. The non-transitory machine readable medium comprises instructions for performing a method, which when executed by a machine, causes the machine to generate a snapshot of a directory by: creating an inode identity map for the snapshot, wherein the inode identity map tracks active inode numbers of files in the directory that have diverged from original inode numbers of the files; and assigning a snapshot generation number to the snapshot, wherein each new snapshot of the directory is assigned an incrementally increasing snapshot generation number; and utilize the inode identity map and the snapshot generation number to provide access to the directory captured by the snapshot.

In some embodiments, a non-transitory machine readable medium is provided. The non-transitory machine readable medium comprises instructions for performing a method, which when executed by a machine, causes the machine to perform operations comprising: generating a snapshot of a directory to manage and protect the directory stored within a storage system, wherein the snapshot is generated within the storage system by: creating an inode identity map for the snapshot, wherein the inode identity map tracks: active inode numbers of files in the directory that have diverged from original inode numbers of the files based upon new versions of files with new inode numbers being created within the storage system in response to the files being modified after creation of the snapshot; and active inode numbers of files newly created in the snapshot stored within the storage system; and assigning a snapshot generation number to the snapshot; in response to the storage system receiving an operation targeting a version of a requested file captured by the snapshot: utilizing the snapshot generation number to determine that the version of the requested file is part of the directory protected by snapshotting; and utilizing the inode identity map to identify a storage location within the storage system of the version of the requested file captured by the snapshot; and executing the operation to access the version of the requested file at the storage location within the storage system.

In some embodiments, the instructions cause the machine to create a delayed free metafile with keys associated with file bock numbers of blocks of storage used to store the snapshot; and utilize the delayed free metafile to determine whether a file block number can be freed in response to an overwrite command for the file block number.

In some embodiments, the instructions cause the machine to maintain a version map that maps keys to values, wherein a key for a file corresponds to an original inode number for the file and a value, mapped to the key, corresponds to a latest inode number for a latest version of the file.

Referring to FIG. 6, a node 600 (also referred to as a storage node) in this example includes processor(s) 601, a memory 602, a network adapter 604, a cluster access adapter 606, and a storage adapter 608 interconnected by a system bus 610. In other examples, the node 600 comprises a virtual machine, such as a virtual storage machine.

The node 600 also includes a storage operating system 612 installed in the memory 602 that can, for example, implement a redundant array of inexpensive disks (RAID) data loss protection and recovery scheme to optimize reconstruction of data of a failed disk or drive in an array, along with other functionality such as deduplication, compression, snapshot creation, data mirroring, synchronous replication, asynchronous replication, encryption, etc.

The network adapter 604 in this example includes the mechanical, electrical and signaling circuitry needed to connect the node 600 to one or more of the client devices over network connections, which may comprise, among other things, a point-to-point connection or a shared medium, such as a local area network. In some examples, the network adapter 604 further communicates (e.g., using Transmission Control Protocol/Internet Protocol (TCP/IP)) via a cluster fabric and/or another network (e.g., a WAN (Wide Area Network)) (not shown) with storage devices of a distributed storage system to process storage operations associated with data stored thereon.

The storage adapter 608 cooperates with the storage operating system 612 executing on the node 600 to access information requested by one of the client devices (e.g., to access data on a data storage device managed by a network storage controller). The information may be stored on any type of attached array of writeable media such as magnetic disk drives, flash memory, and/or any other similar media adapted to store information.

In exemplary data storage devices, information can be stored in data blocks on disks. The storage adapter 608 can include I/O interface circuitry that couples to the disks over an I/O interconnect arrangement, such as a storage area network (SAN) protocol (e.g., Small Computer System Interface (SCSI), Internet SCSI (iSCSI), hyperSCSI, Fiber Channel Protocol (FCP)). The information is retrieved by the storage adapter 608 and, if necessary, processed by the processor(s) 601 (or the storage adapter 608 itself) prior to being forwarded over the system bus 610 to the network adapter 604 (and/or the cluster access adapter 606 if sending to another node computing device in the cluster) where the information is formatted into a data packet and returned to a requesting one of the client devices and/or sent to another node computing device attached via a cluster fabric. In some examples, a storage driver 614 in the memory 602 interfaces with the storage adapter to facilitate interactions with the data storage devices.

The storage operating system 612 can also manage communications for the node 600 among other devices that may be in a clustered network, such as attached to the cluster fabric. Thus, the node 600 can respond to client device requests to manage data on one of the data storage devices or storage devices of the distributed storage system in accordance with the client device requests.

The node 600 may implement a snapshot component 101 configured to perform the techniques described herein such as in relation to FIGS. 1-5. For example, snapshot component 101 may be configured to perform directory snapshot and data management.

In the example node 600, memory 602 can include storage locations that are addressable by the processor(s) 601 and adapters 604, 606, and 608 for storing related software application code and data structures. The processor(s) 601 and adapters 604, 606, and 608 may, for example, include processing elements and/or logic circuitry configured to execute the software code and manipulate the data structures.

The storage operating system 612, portions of which are typically resident in the memory 602 and executed by the processor(s) 601, invokes storage operations in support of a file service implemented by the node 600. Other processing and memory mechanisms, including various computer readable media, may be used for storing and/or executing application instructions pertaining to the techniques described and illustrated herein.

The examples of the technology described and illustrated herein may be embodied as one or more non-transitory computer or machine readable media, such as the memory 602, having machine or processor-executable instructions stored thereon for one or more aspects of the present technology, which when executed by processor(s), such as processor(s) 601, cause the processor(s) to carry out the steps necessary to implement the methods of this technology, as described and illustrated with the examples herein. In some examples, the executable instructions are configured to perform one or more steps of a method described and illustrated later.

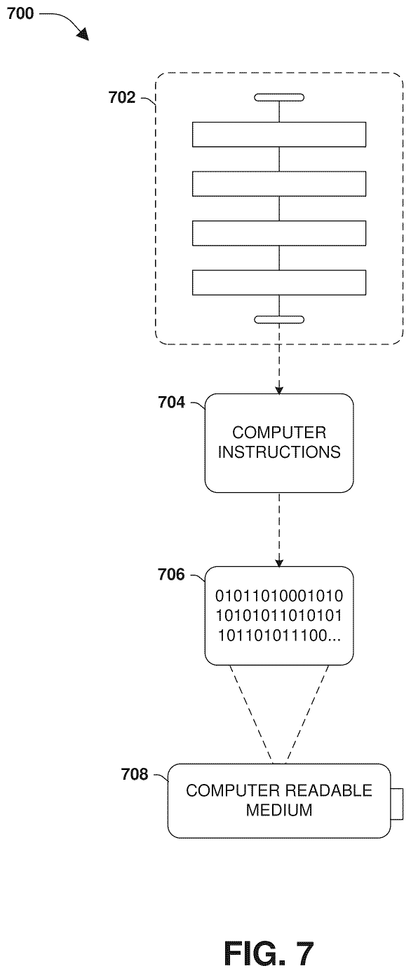

Still another embodiment involves a computer-readable medium 700 comprising processor-executable instructions configured to implement one or more of the techniques presented herein. An example embodiment of a computer-readable medium or a computer-readable device that is devised in these ways is illustrated in FIG. 7, wherein the implementation comprises a computer-readable medium 708, such as a compact disc-recordable (CD-R), a digital versatile disc-recordable (DVD-R), flash drive, a platter of a hard disk drive, etc., on which is encoded computer-readable data 706. This computer-readable data 706, such as binary data comprising at least one of a zero or a one, in turn comprises processor-executable computer instructions 704 configured to operate according to one or more of the principles set forth herein. In some embodiments, the processor-executable computer instructions 704 are configured to perform a method 702 such as method 200 of FIG. 2A. In some embodiments, the processor-executable computer instructions 704 are configured to implement a system such as system 100 of FIG. 1 and/or system 300 of FIG. 3A. Many such computer-readable media are contemplated to operate in accordance with the techniques presented herein.

In an embodiment, the described methods and/or their equivalents may be implemented with computer executable instructions. Thus, in an embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (Saas) architecture, a smart phone, and so on. In an embodiment, a computing device is implemented with one or more executable algorithms that are configured to perform any of the disclosed methods.

It will be appreciated that processes, architectures and/or procedures described herein can be implemented in hardware, firmware and/or software. It will also be appreciated that the provisions set forth herein may apply to any type of special-purpose computer (e.g., file host, storage server and/or storage serving appliance) and/or general-purpose computer, including a standalone computer or portion thereof, embodied as or including a storage system. Moreover, the teachings herein can be configured to a variety of storage system architectures including, but not limited to, a network-attached storage environment and/or a storage area network and disk assembly directly attached to a client or host computer. Storage system should therefore be taken broadly to include such arrangements in addition to any subsystems configured to perform a storage function and associated with other equipment or systems.

In some embodiments, methods described and/or illustrated in this disclosure may be realized in whole or in part on computer-readable media. Computer readable media can include processor-executable instructions configured to implement one or more of the methods presented herein, and may include any mechanism for storing this data that can be thereafter read by a computer system. Examples of computer readable media include (hard) drives (e.g., accessible via network attached storage (NAS)), Storage Area Networks (SAN), volatile and non-volatile memory, such as read-only memory (ROM), random-access memory (RAM), electrically erasable programmable read-only memory (EEPROM) and/or flash memory, compact disk read only memory (CD-ROM) s, CD-Rs, compact disk re-writeable (CD-RW) s, DVDs, cassettes, magnetic tape, magnetic disk storage, optical or non-optical data storage devices and/or any other medium which can be used to store data.

Some examples of the claimed subject matter have been described with reference to the drawings, where like reference numerals are generally used to refer to like elements throughout. In the description, for purposes of explanation, numerous specific details are set forth in order to provide an understanding of the claimed subject matter. It may be evident, however, that the claimed subject matter may be practiced without these specific details. Nothing in this detailed description is admitted as prior art.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated given the benefit of this description. Further, it will be understood that not all operations are necessarily present in each embodiment provided herein. Also, it will be understood that not all operations are necessary in some embodiments.

Furthermore, the claimed subject matter is implemented as a method, apparatus, or article of manufacture using standard application or engineering techniques to produce software, firmware, hardware, or any combination thereof to control a computer to implement the disclosed subject matter. The term “article of manufacture” as used herein is intended to encompass a computer application accessible from any computer-readable device, carrier, or media. Of course, many modifications may be made to this configuration without departing from the scope or spirit of the claimed subject matter.

As used in this application, the terms “component”, “module,” “system”, “interface”, and the like are generally intended to refer to a computer-related entity, either hardware, a combination of hardware and software, software, or software in execution. For example, a component includes a process running on a processor, a processor, an object, an executable, a thread of execution, an application, or a computer. By way of illustration, both an application running on a controller and the controller can be a component. One or more components residing within a process or thread of execution and a component may be localized on one computer or distributed between two or more computers.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, or variants thereof are used, such terms are intended to be inclusive in a manner similar to the term “comprising”.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first set of information and a second set of information generally correspond to set of information A and set of information B or two different or two identical sets of information or the same set of information.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method comprising:
generating a snapshot of a directory to manage and protect the directory stored within a storage system, wherein the snapshot is generated within the storage system by:
creating an inode identity map for the snapshot, wherein the inode identity map tracks:
active inode numbers of files in the directory that have diverged from original inode numbers of the files based upon new versions of files with new inode numbers being created within the storage system in response to the files being modified after creation of the snapshot; and
active inode numbers of files newly created in the snapshot stored within the storage system; and
assigning a snapshot generation number to the snapshot;
in response to the storage system receiving an operation targeting a version of a requested file captured by the snapshot:
utilizing the snapshot generation number to determine that the version of the requested file is part of the directory protected by snapshotting; and
utilizing the inode identity map to identify a storage location within the storage system of the version of the requested file captured by the snapshot; and
executing the operation to access the version of the requested file at the storage location within the storage system.

2. The method of claim 1, comprising:
tracking versions of a file within the directory based upon the file being modified across different snapshots and an active file system by mapping an original inode number of the file to subsequently generated inode numbers for the versions of the file.

3. The method of claim 1, comprising:
tracking, within a version map, versions of a file modified across different snapshots and an active file system by mapping an original inode number of the file to subsequently generated inode numbers for the versions of the file;
providing the original inode number to a file requestor; and
in response to receiving an operation from the file requestor for the file, utilizing the version map to identify an inode number of a version of the file targeted by the operation, wherein the operation includes the original inode number used as a lookup into the version map.

4. The method of claim 1, comprising:
executing an operation to modify a file captured by the snapshot, wherein a new file is created with a new inode number different than an original inode number of the file captured by the snapshot, wherein at least some inode content is shared amongst the original inode number and the new inode number; and
in response to receiving an access operation for the file, utilizing a version map to direct the access operation to the new file having the new inode number, wherein the access operation specifies the original inode number used as a lookup to identify the new inode number.

5. The method of claim 1, comprising:
utilizing a block-freeing mechanism to protect blocks shared between snapshots of the directory and an active file system, wherein the block-freeing mechanism selectively frees file block numbers based upon whether the file block numbers are overwritten in the active file system and exist in at least one snapshot.

6. The method of claim 1, comprising:
selectively utilizing reference counting for a first set of shared blocks between multiple writeable versions of data; and
selectively utilizing a block-freeing mechanism for a second set of shared blocks between a readable version and a single writeable version of data, wherein the reference counting is disabled for the second set of shared blocks.

7. The method of claim 1, comprising:
maintaining a delayed free metafile with keys associated with file bock numbers of blocks of storage used to store the snapshot; and
utilizing the delayed free metafile to determine whether a file block number can be freed in response to an overwrite command for the file block number.

8. The method of claim 1, comprising:
tracking versions of the files within the directory utilizing file version hierarchies to track different inodes used for different versions of a file.

9. The method of claim 1, comprising:
performing a consistency point to store modified data from buffers to storage, wherein the modified data corresponds to client input/output (I/O) operations redirected to the buffers based upon the directory being fenced during creation of the snapshot; and
in response to the snapshot being created, unfencing the directory to unsuspend client I/O operations.

10. The method of claim 1, comprising:
creating a version map that maps keys to values, wherein a key for a file corresponds to an original inode number for the file and a value, mapped to the key, corresponds to a latest inode number for a latest version of the file.

11. The method of claim 1, comprising:
utilizing the snapshot generation numbers as part of a traversal through the snapshot of the directory, wherein each top directory associated with two snapshots is unique.

12. The method of claim 1, comprising:
in response to modifying a file of the directory for a first time, increasing the snapshot generation number for a new version of the file that is created based upon the modification of the file.

13. The method of claim 1, comprising:
executing a background scanner to scan directories to determine whether a file is part of a protected directory for which snapshotting is enabled.

14. A computing device, comprising:
a memory comprising machine executable code; and
a processor coupled to the memory, the processor configured to execute the machine executable code to cause the computing device to:
generate a snapshot of a directory to manage and protect the directory stored within a storage system, wherein the snapshot is generated within the storage system by:
create an inode identity map for the snapshot, wherein the inode identity map tracks:
active inode numbers of files in the directory that have diverged from original inode numbers of the files based upon new versions of files with new inode numbers being created within the storage system in response to the files being modified after creation of the snapshot; and
active inode numbers of files newly created in the snapshot stored within the storage system; and
assign a snapshot generation number to the snapshot;
in response to the storage system receiving an operation targeting a version of a requested file captured by the snapshot:
utilize the snapshot generation number to determine that the version of the requested file is part of the directory protected by snapshotting; and
utilize the inode identity map to identify a storage location within the storage system of the version of the requested file captured by the snapshot; and
execute the operation to access the version of the requested file at the storage location within the storage system.

15. The computing device of claim 14, wherein the machine executable code causes the computing device to:
track versions of a file within the directory based upon the file being modified across different snapshots and an active file system by mapping an original inode number of the file to subsequently generated inode numbers for the versions of the file.

16. The computing device of claim 14, wherein the machine executable code causes the computing device to:
track, within a version map, versions of a file modified across different snapshots and an active file system by mapping an original inode number of the file to subsequently generated inode numbers for the versions of the file; and
in response to receiving an operation from a file requestor for the file, utilize the version map to identify an inode number of a version of the file targeted by the operation, wherein the operation includes the original inode number used as a lookup into the version map.

17. The computing device of claim 14, wherein the machine executable code causes the computing device to:
execute an operation to modify a file captured by the snapshot, wherein a new file is created with a new inode number different than an original inode number of the file captured by the snapshot, wherein at least some inode content is shared amongst the original inode number and the new inode number.

18. A non-transitory machine readable medium comprising instructions for performing a method, which when executed by a machine, causes the machine to:
generate a snapshot of a directory to manage and protect the directory stored within a storage system, wherein the snapshot is generated within the storage system by:
create an inode identity map for the snapshot, wherein the inode identity map tracks:
active inode numbers of files in the directory that have diverged from original inode numbers of the files based upon new versions of files with new inode numbers being created within the storage system in response to the files being modified after creation of the snapshot; and
active inode numbers of files newly created in the snapshot stored within the storage system; and
assign a snapshot generation number to the snapshot;
in response to the storage system receiving an operation targeting a version of a requested file captured by the snapshot:
utilize the snapshot generation number to determine that the version of the requested file is part of the directory protected by snapshotting; and
utilize the inode identity map to identify a storage location within the storage system of the version of the requested file captured by the snapshot; and
execute the operation to access the version of the requested file at the storage location within the storage system.

19. The non-transitory machine readable medium of claim 18, wherein the instructions cause the machine to:
create a delayed free metafile with keys associated with file bock numbers of blocks of storage used to store the snapshot; and
utilize the delayed free metafile to determine whether a file block number can be freed in response to an overwrite command for the file block number.

20. The non-transitory machine readable medium of claim 18, wherein the instructions cause the machine to:
maintain a version map that maps keys to values, wherein a key for a file corresponds to an original inode number for the file and a value, mapped to the key, corresponds to a latest inode number for a latest version of the file.
